(19) United States
(12) Patent Application Publication
(10) Pub. No.: US 2022/0214157 A1
(43) Pub. Date: Jul. 7, 2022

(54) DEVICE AND METHOD FOR MEASURING DEFORMATION IN METALLIC BARS

(71) Applicant: THINGWAVE AB, Gammelstad (SE)

(72) Inventor: Jens ELIASSON, Gammelstad (SE)

(73) Assignee: THINGWAVE AB, Gammelstad (SE)

(21) Appl. No.: 17/610,082

(22) PCT Filed: May 15, 2020
(86) PCT No.: PCT/SE2020/050508

§ 371 Date: Nov. 9, 2021

(30) Foreign Application Priority Data
May 15, 2019 (SE) 1950575-9

(51) Int. Cl. G01B 11/16; G01B 11/02; G01B 5/30

(52) U.S. Cl. CPC G01B 11/16; G01B 2210/66; G01B 5/30; G01B 11/026

(57) ABSTRACT

A device for measuring strain in an elongated metallic bar, the device comprising a housing arranged to be secured to the metallic bar, at least one optical sensor, at least one light source arranged to emit light across an interior space of the housing, and a thread arranged freely movable within a sheath and having a proximal end extending to a distal end of the housing and a distal free end arranged to be attached to the metallic bar at a distance from the housing such that longitudinal deformation of the metallic bar causes displacement of the proximal end of the thread in relation to the housing, and wherein the at least one optical sensor is configured to measure the displacement of the proximal end of the thread by measuring light emitted from the at least one light source.

### TECHNICAL FIELD

The present disclosure relates generally to new and useful improvements in metallic bars such as e.g. rock bolts, more specifically devices and methods for measuring strain, integrity and/or seismicity on metallic bars/rock bolts as well as a reinforcement system including metallic bars/rock bolts comprising such a sensor device.

### BACKGROUND ART

Bolting is the most common reinforcement of rock that is exposed to slow deformation or sudden fracture. Fundamental requirements for rock bolts are that they are to support a heavy load and to resist a large degree of bending before the bolt breaks. A large number of rock bolts introduced into boreholes and anchored in them by means of embedding in grout form together a reinforcement system that stabilises and reinforces the rock structure during the building of tunnels, mining operations, tunnelling, etc.

Several different types of bolt intended for such reinforcement systems are available, including “fully grouted” bolts and “end-anchored” bolts. Bolts of the end-anchored type normally have at their forward end an anchor arrangement such as a wedge for mechanical anchoring at the bottom of the borehole, and the tension in the bolt is more or less constant over its length. Fully grouted bolts achieve their principal load-bearing ability through adhesion along the complete length of the rock bolt that by means of grout or epoxy resin. The load distribution in this case is more complex and varies depending on factors such as (i) the physical properties of the bolt, (ii) the installation procedure, (iii) the grout or epoxy resin bond between the bolt and the rock borehole and (iv) the distribution of movement in the rock mass surrounding the bolt.

Rock reinforcement systems that are used in fracture-rich rock are subject to heavy loads. The rock bolts may be placed under load locally at locations at which they cross large fractures between blocks, and thus subject to heavy loads that lead to the bolts becoming deformed, mainly through bending and extension. In certain cases, the load exceeds the ability of the rock bolt to absorb force, such that breaks of the rock bolt arise, i.e. the integrity of the bolt fails, whereby the reinforcement system is weakened. There is therefore a need to precisely and accurately measure the strain to which the rock bolt is subjected.

WO 2016/076788 discloses an arrangement for a rock bolt that is intended to be embedded in grout in a borehole, a method for using said arrangement, and a reinforcement system including such an arrangement. The rock bolt is equipped with a longitudinal tube with a passage, wherein an extended electrically conducting sensor is introduced into the passage of the tube and the sensor is connected with the anchoring end of the rock bolt, a monitoring arrangement designed to be connected to the rock bolt, that an electrically conducting circuit is formed through the connection of the rock bolt, the sensor and the monitoring arrangement, wherein the monitoring arrangement includes evaluation means intended to evaluate the presence of changes in the condition of the bolt, and signaling means designed for the signaling of the condition of the bolt. However, the external placement of the tube with the electrically conducting wire precludes use with epoxy resin as embedding material, since the resin will tear the wire apart during mixing and curing of the resin components.

US 2013/0054156 discloses a strain measuring and monitoring device comprising inductive displacement sensors bonded by means of strong epoxy resin in lateral longitudinal grooves in a metallic bar.

However, the known solutions are expensive, bulky and/or have high energy consumption and may therefore not be easily integrated in common rock bolts. As such, they preclude large-scale, long-term monitoring of rock bolts in a rock reinforcement system.

Thus, there is a need for an improved measurement solution which is inexpensive, has low power consumption, takes up little space and is easy to integrate with different types of rock bolts.

### SUMMARY OF INVENTION

An object of the present disclosure is to provide an improved measurement solution which achieves these advantages. This object is achieved in a first aspect of the invention, in which there is provided a device for measuring strain in an elongated metallic bar, the device comprising a housing arranged to be secured to the metallic bar, at least one optical sensor, at least one light source arranged to emit light across an interior space of the housing, and a thread arranged freely movable within a sheath and having a proximal end extending to a distal end of the housing and a distal free end arranged to be attached to the metallic bar at a distance from the housing such that longitudinal deformation of the metallic bar causes displacement of the proximal end of the thread in relation to the housing, and wherein the at least one optical sensor is configured to measure the displacement of the proximal end of the thread by measuring light emitted from the at least one light source.

By means of the thread moving freely in the sheath, it is possible to transfer longitudinal deformation of a distal portion of the metallic bar to the housing of the strain measuring device, which may be arranged near the proximal end of the metallic bar. The at least one optical sensor and the at least one light source enable measuring the longitudinal deformation and determining the strain with high accuracy and reduced cost compared to conventional strain measuring devices and methods. The housing may be of compact dimensions to facilitate mounting on the metallic bar. One further advantage over conventional devices and methods such as electrical strain gauges or inductive displacement sensors is that the at least one optical sensor and the at least one light source do not require continuous operation in order to determine a change in distance. Hence, energy consumption is considerably lower compared to conventional devices and methods.

In one embodiment, the housing comprises a plurality of optical sensors and light sources arranged opposite one another along a longitudinal extension of the housing, and wherein the proximal end of the thread is attached to a slidable plug which occludes the interior space of the housing. This configuration allows for precise measurement of the displacement through determination of the position of the plug by gleaning information from a plurality of optical sensors in combination.

In one embodiment, the at least one optical sensor is arranged in a proximal end of the housing. This configuration enables determining the displacement by measuring the distance travelled by the light emitted by the at least one light source in a longitudinal direction of the housing.

In one embodiment, the housing is cylindrical and comprises two nested slidable portions, and wherein the proximal end of the thread is attached to a distal portion of the housing. In this configuration, the displacement of the proximal end of the thread will be transferred to the distal portion to slide in relation to the proximal portion of the housing. The nested slidable configuration of the two portions of the housing allows for optimal control of the sliding movement between the proximal and distal portions of the housing as well as protecting the at least one optical sensor within the housing.

In one embodiment, the at least one light source is associated with the proximal end of the thread. The at least one light source may be attached to the proximal end of the thread and the distal portion of the housing may be open-ended providing a transition to the sheath which accommodates the thread. Alternatively, with the nested slidable configuration of the housing, the at least one light source may be arranged in the distal end of the housing.

In one embodiment, the at least one light source is a light-emitting diode, LED. LEDs are inexpensive, reliable and have a low energy consumption which enables wide-scale, long-term deployment at reduced cost compared to known devices and methods.

In one embodiment, the at least one optical sensor is configured to measure the light intensity of the at least one light source in order to determine the displacement of the proximal end of the thread in relation to the housing. The longitudinal deformation may then be calculated by using the light intensity detected by each of the plurality of optical sensors to precisely determine the position of the plug in the housing. Alternatively, the longitudinal deformation may be determined by using the correlation between light intensity and distance.

This method provides distance measurement with an accuracy of ±0.1 mm which enables precise calculation of the strain exerted on the rock bolt. Optionally, several sensors can be placed on the metallic bar, and thus strain measurements can be obtained for different segments of the metallic bar.

In one embodiment, the at least one optical sensor and the at least one light source is an optical distance measurement sensor comprising lidar arranged to measure the length of the housing. The lidar provides distance measurement with an accuracy of ±1 mm which enables precise calculation of the strain exerted on the rock bolt.

In one embodiment, the at least one optical sensor is configured to measure the time-of-flight of a light signal emitted by the at least one light source in order to determine the displacement of the proximal end of the thread in relation to the housing. The time-of-flight measurement provides an alternative distance measurement with similar or improved accuracy compared to using the light intensity.

In one embodiment, the strain measuring device further comprises a microcontroller operatively connected to the strain measuring device and configured to receive longitudinal deformation values measured by the strain measuring device, wherein the microcontroller comprises means for wireless communication with an external unit. Through wireless communication, the measured values of longitudinal deformation of the metallic bar may be transmitted to a remotely arranged unit enabling remote monitoring of the strain exerted on the metallic bar.

In a further preferred embodiment, the strain measuring device further comprises a vibration sensor arranged to measure seismic energy exerted on the metallic bar. The vibration sensor provides additional information on forces acting on the metallic bar to enable monitoring of several variables relevant in determining overall status of the metallic bar and the environment where it is installed.

In one embodiment, the strain measuring device further comprises one or more conductive wires arranged to be attached to the metallic bar at a distance from the housing to form one or more electrical circuits for determining the integrity of the metallic bar. The conductive wires provide an inexpensive alternative for monitoring whether the metallic bar is intact, i.e. whether a break has occurred or not.

In a second aspect of the present disclosure, there is provided a metallic bar comprising at least one strain measuring device according to the first aspect mounted thereon. Preferably, the metallic bar comprises a plurality of strain measuring devices, wherein the distal free ends of the threads of each strain measuring device are attached at different longitudinal positions along the length of the metallic bar. This enables measuring longitudinal deformation and monitoring strain for different segments along the whole length of the metallic bar. The metallic bar may be a rock bolt, a rebar, a threaded bolt or a friction bolt.

In one embodiment, the metallic bar is hollow and the at least one strain measuring device is mounted in an interior cavity of the metallic bar. In this configuration, the thread runs inside the interior cavity which constitutes the sheath. The internal mounting of the strain measuring device reduces the risk of external influence on the strain measuring device, e.g. during installation in a borehole using grout or resin.

In a third aspect of the present disclosure, there is provided a method for determining strain exerted on an elongated metallic bar, the method comprising:
mounting at least one strain measuring device according to the first aspect on the metallic bar;
attaching the distal free end of the thread to the metallic bar at a distance from the housing such that the thread is taut;
measuring longitudinal deformation of the metallic bar by means of the at least one strain measuring device; and
determining the strain exerted on the metallic bar based on the measured deformation.

The method makes use of the novel strain measuring device according to the first aspect to achieve a low-cost, reliable way of determining strain on a metallic bar with low energy consumption which allows for wide-scale, long-term deployment and monitoring of e.g. reinforcement systems in rock walls in mines or tunnels.

In one embodiment, the method further comprises determining seismic energy exerted on the metallic bar based on vibration measured by a vibration sensor of the at least one strain measuring device. The measurement of vibration provides additional information to give a more comprehensive overview of the forces acting on the metallic bar.

In one embodiment, the method further comprises attaching one or more conductive wires between the at least one strain measuring device and the metallic bar at a distance from the housing to form one or more electrical circuits; and determining the integrity of the metallic bar by passing electrical current through the one or more electrical circuits. The conductive wires provide an inexpensive alternative for monitoring whether the metallic bar is intact, i.e. whether a break has occurred or not.

### BRIEF DESCRIPTION OF DRAWINGS

The invention is now described, by way of example, with reference to the accompanying drawings, in which:

FIG. 1 shows a cross-sectional side view of a rock bolt comprising a strain measuring device according to one embodiment of the present disclosure, installed in a bore hole in a rock wall; and

FIGS. 2A and 2B show cross-sectional side views of a strain measuring device according to one embodiment of the present disclosure;

FIGS. 3A and 3B show cross-sectional side views of a strain measuring device according to another embodiment of the present disclosure; and

FIG. 4 shows a cross-sectional view of a strain measuring device according to another embodiment of the present disclosure.

### DESCRIPTION OF EMBODIMENTS

In the following, a detailed description of a strain measuring and monitoring device according to the present disclosure is presented. In the drawing figures, like reference numerals designate identical or corresponding elements throughout the several figures. It will be appreciated that these figures are for illustration only and are not in any way restricting the scope of the invention.

Although the example embodiments of the strain measuring and monitoring device are discussed in examples below with respect to rock bolts, it will be appreciated by those of ordinary skill in the art that the strain measurement and monitoring device of the present disclosure can be used in association with any sort of metallic bar structure, such as concrete rebars, friction bolts, threaded bolts, cables and other flexible steel tendons such as cable bolts and is not limited to the measurement and monitoring of strain in rock bolts. In the following, the terms are used interchangeably and should not be construed as limiting the scope of protection.

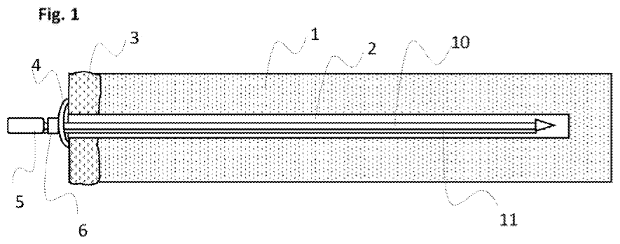

In FIG. 1, there is shown an example illustrating the use of the strain measuring device according to the present disclosure. In a rock wall 1, for instance in a mine or a tunnel, there is drilled a bore hole 2 for mounting a rock bolt 10 therein. The rock bolt 10 may thus be inserted and extends towards the distal end of the bore hole 2 to provide reinforcement of the rock wall 1. A plurality of rock bolts 10 may be installed to form a reinforcement system to secure the rock wall 1 during subsequent operation in the mine or tunnel. As explained above, the rock bolt 10 is anchored in the bore hole 2 by means of grout or epoxy resin to provide substantially complete adhesion between the rock bolt 10 and the rock wall 1. Along the face of the rock wall 2, a layer of shotcrete 3 is applied to further secure the rock wall 2. Once the grout or epoxy resin as well as the shotcrete layer 3 have set, the rock bolt 10 is tightened by means of an anchor plate 4 and a nut 6.

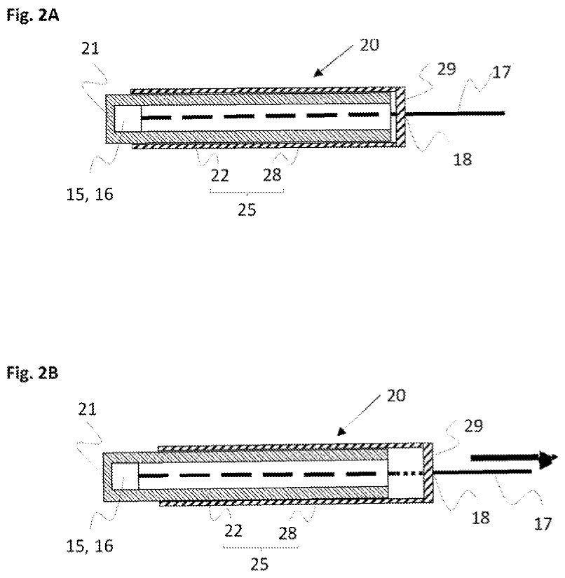

In order to monitor the condition of the reinforcement and the rock wall 1, a strain measuring device according to the present disclosure may be installed on the rock bolt 10. Turning now to FIGS. 2A and 2B, there is shown a schematic, cross-sectional view of a strain measuring device 20 in accordance with one embodiment of the present disclosure. The strain measuring device 20 comprises a cylindrical housing 25 including two portions 22, 28 slidably nested within one another. In this example, the proximal portion 22 is nested within the distal portion 28, but it is also foreseen that the distal portion 28 may be nested within the proximal portion 22. An optical sensor 15 is arranged in a proximal end 21 of the housing 25. The optical sensor 15 is arranged to measure the length of the housing 25 by means of light emitted from a light source 16, as indicated by the dashed line in FIG. 2A. In this embodiment, the optical sensor 15 and the light source 16 are incorporated into one unit, e.g. in the form of an optical distance measurement sensor comprising lidar, an acronym of light detection and ranging of laser imaging, detection, and ranging. The light emitted by the light source 16 travels across the interior space of the housing 25 towards the distal end 29 and is reflected back towards the optical sensor 15. Lidar measures the time-of-flight of the emitted light signal from the light source 16 to its return to the optical sensor 15 and uses it to calculate the distance travelled by the emitted light. Time-of-flight measurement may also be used in other configurations of optical sensor(s) 15 and light source(s) 16 of the present disclosure to calculate distances.

The strain measuring device 20 further comprises a thread 17, preferably non-conducting, arranged freely movable in a sheath 11 adapted to extend along the length of the rock bolt 10, as illustrated in FIG. 1. Preferably, the strain measuring device and the sheath 11 is installed in a longitudinal recess formed in the external surface of the rock bolt 10 and covered with e.g. epoxy resin which is allowed to set before installing the rock bolt 10 in the rock wall 1. In this way, the thread is free to move within the sheath 11 in response to movement of the rock bolt 10, unaffected by the grout or resin in the borehole 2. Alternatively, the rock bolt 10 is hollow and the hollowness constitutes the sheath 11 in which the strain measuring device (20; 30; 40) is provided, i.e. the strain measuring device is installed in the interior cavity of the rock bolt 10. In the latter case, the sheath 11 is optional as the thread 17 will not be exposed to the borehole 2.

The proximal end 18 of the thread 17 is attached to the distal portion 28 of the housing 25 in a distal end 29 thereof. In one embodiment, the housing 25 is fully or partially arranged within the sheath 11. Alternatively, it is foreseen that the sheath 11 is attached to the housing 25. The distal free end (not shown) of the thread 17 is configured to be attached to the rock bolt 10 at a distance from the housing 25 in such a way that longitudinal deformation of the rock bolt 10 causes displacement of the thread 17 and thus the distal portion 28 of the housing 25 attached thereto, as illustrated by the arrow in FIG. 2B. The proximal portion 22 of the housing 25 is configured to be attached to the rock bolt 10 such that displacement of the distal portion 28 causes it to slide in relation to the proximal portion 22.

As an alternative to the time-of-flight measurement mentioned above, it is foreseen in the present disclosure to determine a distance by using the intensity of the light detected by the optical sensor 15, also known as irradiance which is defined as the radiant flux (power) received by a surface per unit area with the SI unit watt per square metre (W/m²). It is well known that the intensity of light emitted by a light source decreases in proportion to the distance squared. By comparing the intensity (irradiance) of the light detected by the optical sensor 15 to the known intensity of the light emitted by the light source 16, it is possible to calculate the distance travelled by the light from the difference. When the difference in intensity varies, the optical sensor 15 can measure changes in length of the housing indicated by the dotted line in FIG. 2B. This change in length of the housing 25 is indicative of the strain exerted on the rock bolt 10 which may then be determined based on the measured longitudinal deformation.

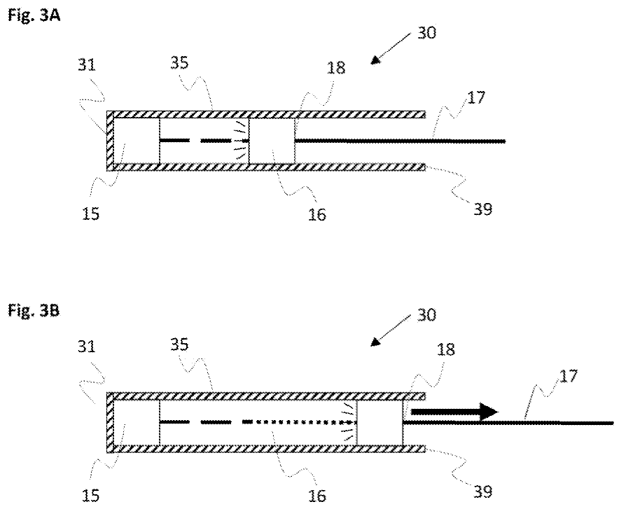

Turning now to FIGS. 3A and 3B, there is shown a schematic, cross-sectional view of a strain measuring device 30 in accordance with another embodiment of the present disclosure. The strain measuring device 30 comprises a cylindrical, tubular housing 35. An optical sensor 15 is arranged in a closed proximal end 31 of the housing 25. Similar to the embodiment in FIGS. 2A and 2B, a thread 17 is arranged freely movable within the sheath 11 with its proximal end 18 extending into the housing 35, wherein the distal free end (not shown) of the thread 17 is arranged to be attached to the rock bolt 10 at a distance from the housing 35. The optical sensor 15 is arranged to determine the displacement of the proximal end 18 of the thread 17 in relation to the housing 35. This is done by measuring the distance between the proximal end 31 of the housing 35 and a light source 16 associated with the proximal end 18 of the thread 17 by means of light emitted from the light source 16, as indicated by the dashed line in FIG. 3A. In this embodiment, the optical sensor 15 and the light source 16 are arranged as two separate units, as the light source 16, e.g. in the form of a light-emitting diode (LED) is attached to the proximal end 18 of the thread 17 and capable of sliding inside the housing 35 in response to displacement of the thread caused by deformation and strain exerted on the metallic bar 10. The diameter of the light source 16 may be adapted to the inner diameter of the housing 35 such that it contacts the inner walls of the housing 35. This will stabilise the sliding movement. In one embodiment combining the embodiments of FIGS. 2A, 2B and FIGS. 3A, 3B, the light source 16 may be provided at the point of attachment between the thread 17 and the distal end 29 of the distal portion 28 of the housing 25 such that light is emitted towards the optical sensor 15 inside the housing 25.

Similar to the embodiment of FIG. 2B, longitudinal deformation of the rock bolt 10 causes the proximal end 18 of the thread 17 with the light source 16 to be displaced in relation to the proximal end 31 of the housing 35 and the optical sensor 15. By means of the light emitted by the light source 16, the optical sensor 15 measures the change in distance between the optical sensor 15 and the proximal end 18 of the thread 17, indicated by the dotted line in FIG. 3B. This change in distance is indicative of the strain exerted on the rock bolt 10 which may then be determined based on the measured longitudinal deformation.

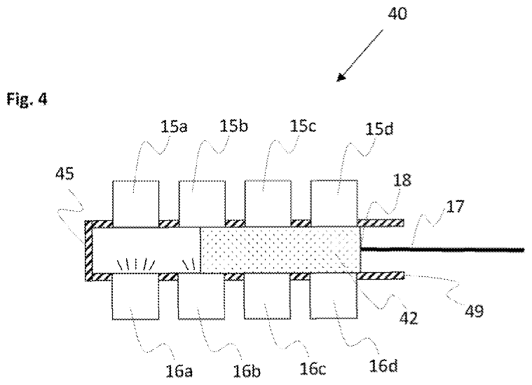

Referring now to FIG. 4, there is shown another embodiment of the present disclosure in a cross-sectional view. In this embodiment, the strain measuring device 40 comprises a housing 45 with an open distal end similar to the embodiment of FIGS. 3A and 3B to allow entry of the thread 17 therein. The housing 45 comprises a plurality of optical sensors 15a-d and a plurality of light sources 16a-d which are arranged opposite one another along the length of the housing 45. Each light source 16a-d is thus paired with a corresponding optical sensor 15a-d, preferably at regular intervals along the housing 45. In the embodiment shown in FIG. 4, four pairs of optical sensor 15a-d and light source 16a-d are shown, but it is foreseen that the number can be varied within the scope of the present disclosure.

Slidably arranged in the housing 45 is a plug 42 which is attached to the proximal end 18 of the thread 17. The plug 42 is dimensioned with a diameter adapted to the inner diameter of the housing 45 such that the plug 42 occludes the interior space of the housing 45. Light emitted by the light sources 16a-d will then be blocked and thus does not reach the oppositely arranged optical sensors 15a-d. Since the position of each pair of optical sensor 15a-d and light source 16a-d is known, this configuration can be used to determine displacement of the proximal end 18 of the thread 17 in relation to the housing 45, and thus the strain exerted on the metallic bar 10. In the situation illustrated in FIG. 4, the first optical sensor 15a closest to the proximal end of the housing 45 receives substantially 100% of the light emitted by the first light source 16a, whereas the second optical sensor 15b receives approximately 50% of the light emitted by the second light source 16b. The third and fourth light sources 16c and 16d are occluded by the plug 42, thus the third and fourth optical sensors 15c and 15d detect no light. Consequently, the position of the plug 42 in the housing 45 can be determined by combining the information gleaned from the plurality of optical sensors 15a-d.

Major advantages over the prior art, apart from the simplicity of the solution with the optical sensor 15 to reduce the cost of the strain measuring device 20; 30; 40, include precision in measuring longitudinal deformation of the rock bolt 10 as well as reduced cost due to lower energy consumption. Contrary to e.g. inductive sensors as known in the art, the strain measuring device 20; 30; 40 according to the present disclosure only requires intermittent power of the light source 16 and optical sensor 15 to provide accurate measurements of longitudinal deformation in the rock bolt 10 based on the relative displacement of the proximal end 18 of the thread 17 with respect to the optical sensor 15.

Reverting to FIG. 1, the strain measuring device 20; 30; 40 may further be operatively connected to a microcontroller 5 arranged in a proximal end of the rock bolt 10 outside the bore hole 2. The microcontroller 5 is arranged to receive the measured values of longitudinal deformation from the strain measuring device 20; 30; 40 and further comprises means for wireless communication with an external unit. Thus, the microcontroller 5 may determine the strain exerted on the rock bolt 10 and/or transmit the information, e.g. to a remotely located central server to provide remote monitoring of the strain conditions in the rock wall 1 in which the rock bolt 10 is installed.

In order to provide additional information about the state of the rock wall 1, the strain measuring device according to the present disclosure may be provided with additional sensors. In one embodiment, the strain measuring device further comprises a vibration sensor (not shown) adapted to measure seismic energy exerted on the rock bolt 10. Thus, the vibration sensor provides information about seismic activity in the rock wall 1 which enables prediction of dangerous situations, e.g. with breaks of the rock bolt 10.

In another embodiment, the strain measuring device further comprises one or more conductive wires which may be attached between the housing 25; 35 and different positions along the longitudinal extension of the rock bolt 10 to form an electrical circuit. In this way, the integrity of the rock bolt 10 may be monitored by intermittently passing current through the electrical circuit. In case of breakage of the rock bolt 10 due to forces exerted thereon by the rock wall 1, the electrical circuit will be broken such that no current may pass through it. With a plurality of such electrical circuits attached at different longitudinal positions along the length of the rock bolt 10, it is possible to determine at which longitudinal position the breakage has occurred.

Optionally, foreseen in the present disclosure is a reinforcement system for a rock wall in e.g. a mine or tunnel comprising a plurality of rock bolts, each having one or more strain measuring devices according to the present disclosure mounted thereon.

Preferred embodiments of a device and method for measuring strain in metallic bars have been disclosed above. However, a person skilled in the art realises that this can be varied within the scope of the appended claims without departing from the inventive idea.

All the described alternative embodiments above or parts of an embodiment can be freely combined or employed separately from each other without departing from the inventive idea as long as the combination is not contradictory.

1-20. (canceled).

21. A device for measuring strain in an elongated metallic bar, the device comprising a housing arranged to be secured to the metallic bar, at least one optical sensor, at least one light source arranged to emit light across an interior space of the housing, and a thread arranged freely movable within a sheath and having a proximal end extending to a distal end of the housing and a distal free end arranged to be attached to the metallic bar at a distance from the housing such that longitudinal deformation of the metallic bar causes displacement of the proximal end of the thread in relation to the housing, and wherein the at least one optical sensor is configured to measure the displacement of the proximal end of the thread by measuring light emitted from the at least one light source.

22. The strain measuring device according to claim 21, wherein the housing comprises a plurality of optical sensors and light sources arranged opposite one another along a longitudinal extension of the housing, and wherein the proximal end of the thread is attached to a slidable plug which occludes the interior space of the housing.

23. The strain measuring device according to claim 21, wherein the at least one optical sensor is arranged in a proximal end of the housing.

24. The strain measuring device according to claim 23, wherein the housing is cylindrical and comprises two nested slidable portions, and wherein the proximal end of the thread is attached to a distal portion of the housing.

25. The strain measuring device according to claim 23 wherein the at least one light source is associated with the proximal end of the thread.

26. The strain measuring device according to claim 21, wherein the at least one light source is a light-emitting diode, LED.

27. The strain measuring device according to claim 21, wherein the at least one optical sensor is configured to measure the light intensity of the at least one light source in order to determine the displacement of the proximal end of the thread in relation to the housing.

28. The strain measuring device according to claim 24, wherein the at least one optical sensor and the at least one light source is an optical distance measurement sensor comprising lidar arranged to measure the length of the housing.

29. The strain measuring device according to claim 23, wherein the at least one optical sensor is configured to measure the time-of-flight of a light signal emitted by the at least one light source in order to determine the displacement of the proximal end of the thread in relation to the housing.

30. The strain measuring device according to claim 21, further comprising a microcontroller operatively connected to the strain measuring device and configured to receive displacement values measured by the strain measuring device, wherein the microcontroller comprises means for wireless communication with an external unit.

31. The strain measuring device according to claim 21, further comprising a vibration sensor arranged to measure seismic energy exerted on the metallic bar.

32. The strain measuring device according to claim 21, further comprising one or more conductive wires arranged to be attached to the metallic bar at a distance from the housing to form one or more electrical circuits for determining the integrity of the metallic bar.

33. The strain measuring device according to claim 21, wherein metallic bar is hollow and the hollowness constitutes the sheath in which the strain measuring device is provided.

34. A metallic bar comprising at least one strain measuring device according to claim 21 mounted thereon.

35. The metallic bar according to claim 34, comprising a plurality of strain measuring devices, wherein the distal free ends of the threads of each strain measuring device are attached at different longitudinal positions along the length of the metallic bar.

36. The metallic bar according to claim 34, wherein the metallic bar is a rock bolt, a rebar, a threaded bolt or a friction bolt.

37. The metallic bar according to claim 34, wherein the metallic bar is hollow and the at least one strain measuring device is mounted in an interior cavity of the metallic bar.

38. A method for determining strain exerted on an elongated metallic bar, the method comprising:
mounting at least one strain measuring device according to claim 21 on the metallic bar;
attaching the distal free end of the thread to the metallic bar at a distance from the housing such that the thread is taut;
measuring longitudinal deformation of the metallic bar by means of the at least one strain measuring device; and
determining the strain exerted on the metallic bar based on the measured deformation.

39. The method according to claim 38, further comprising:
determining seismic energy exerted on the metallic bar based on vibration measured by a vibration sensor of the at least one strain measuring device.

40. The method according to claim 38, further comprising:
attaching one or more conductive wires between the at least one strain measuring device and the metallic bar at a distance from the housing to form one or more electrical circuits; and
determining the integrity of the metallic bar by passing electrical current through the one or more electrical circuits.
